(19) United States
(12) Patent Application Publication
(10) Pub. No.: US 2026/0112761 A1
(43) Pub. Date: Apr. 23, 2026

(54) Consumer with a Battery Interface

(71) Applicant: Robert Bosch GmbH, Stuttgart (DE)

(72) Inventors: Daniel Barth, Leinfelden-Echterdingen (DE); Florian Esenwein, Leinfelden-Echterdingen (DE)

(21) Appl. No.: 19/358,829

(22) Filed: Oct. 15, 2025

(30) Foreign Application Priority Data
Oct. 18, 2024 (DE) 10 2024 210 123.0

(51) Int. Cl. H01M 50/264; H01M 50/247

(52) U.S. Cl. CPC H01M 50/264; H01M 50/247; H01M 2220/30

(57) ABSTRACT

A consumer having a battery interface for connection to an interchangeable battery pack includes a consumer housing having a receiving space, and a biasing element which is arranged on the consumer housing. The consumer housing is configured such that an interchangeable battery pack can be inserted into the receiving space along an insertion direction. The biasing element is configured and arranged such that it applies a biasing force at least partially orthogonal to the insertion direction on the interchangeable battery pack when it is inserted into the receiving space.

This application claims priority under 35 U.S.C. §119 to application no. DE 10 2024 210 123.0, filed on Oct. 18, 2024 in Germany, the disclosure of which is incorporated herein by reference in its entirety.

### BACKGROUND

The present disclosure relates to a consumer having a battery interface for connection to an interchangeable battery pack.

Consumers are known, for example hand tool electric machines, having interchangeable batteries for supplying electrical power. Such consumers typically have a battery interface by way of which the interchangeable battery pack can be electrically and mechanically connected. Many consumers often experience strong and varying mechanical loads during operation, such as vibrations and oscillations. These also result in high loads on the battery interfaces.

### SUMMARY

In contrast, the consumer according to the disclosure with the features described herein is characterized in that a particularly robust and durable connection of the consumer and the interchangeable battery pack is enabled. In particular, a reliable and durable connection of the consumer and the interchangeable battery pack can be made possible even with frequent and strong changing mechanical loads, such as vibrations, during the operation of the consumer. According to the present disclosure, this is achieved by a consumer with a battery interface for connection to an interchangeable battery pack comprising a consumer housing with a receiving space, and a biasing element arranged on the consumer housing. The consumer housing is configured such that an interchangeable battery pack can be inserted into the receiving space along an insertion direction. The biasing element is configured and arranged such that it applies a biasing force along at least part of a direction orthogonal to the insertion direction on the interchangeable battery pack when it is inserted into the receiving space.

In particular, the consumer housing is configured with the receiving space such that the interchangeable battery pack, preferably exclusively, can be inserted linearly into the receiving space along the insertion direction. That is to say, the interchangeable battery pack can be inserted into the receiving space, in particular exclusively, along the insertion direction configured as a straight line.

Preferably, the biasing element is arranged directly adjacent to the receiving space and/or protrudes at least partially into the receiving space.

In particular, the biasing element is configured and arranged to apply a biasing force to the interchangeable battery pack in the state in which it is inserted into the receiving space, which is at least equal to a predetermined minimum biasing force. Preferably, the minimum biasing force may be at least 10 N, preferably at least 20 N.

In other words, a consumer is provided having a consumer housing with a receiving space and a biasing element, wherein the biasing element can apply a biasing force on an interchangeable battery pack that can be inserted into the receiving space. The biasing force is arranged fully orthogonal to the insertion direction, or has at least one force component that is orthogonal to the insertion direction.

The consumer offers the advantage that the predetermined biasing force is specifically applied to the interchangeable battery pack at any time in each operating state when it is arranged in the receiving space of the consumer housing. The interchangeable battery pack is thus purposefully pressed against a wall of the consumer housing, for example, and is thus fixed in a defined manner in all operating situations. In particular, this may prevent the interchangeable battery pack from moving within the consumer housing during operation of the consumer. In the case of vibrations that can occur during operation of the consumer, the interchangeable battery pack can be purposefully held by the biasing element, which can prevent or reduce loosening and wear of the battery interface. This allows a mechanical and electrical connection of the interchangeable battery pack and the consumer to be provided particularly reliably over a long service life.

Preferred embodiments of the disclosure are also set forth below.

Preferably, the biasing element is formed at least partially, preferably entirely, of a resiliently compliant material. In particular, the biasing element may be made plastic. Preferably, the biasing element is made of polyoxymethylene, or POM for short. Alternatively, for example, the biasing element may be at least partially made of polytetrafluorethylene, for example. The biasing element can thus be produced particularly simply and inexpensively, for example as an injection molding component. In addition, the biasing force can be produced in a particularly simple and effective manner and an easy insertion with low friction is also possible.

Preferably, the biasing element comprises a first biasing region arranged at a first end region of the receiving space located in the insertion direction. In particular, the first end region extends over a maximum of 30%, in particular at least 5%, of an axial length of the receiving space. In other words, the first biasing region of the biasing element is arranged to only act on the interchangeable battery pack when the interchangeable battery pack is already largely inserted into the receiving space. This allows for a particularly simple and smooth insertion of the interchangeable battery pack. In addition, low frictional wear between the biasing element and the interchangeable battery pack of the biasing element and the interchangeable battery pack may be allowed.

Further preferably, the biasing element comprises a second biasing region arranged at a second end region of the receiving space opposite the insertion direction. In particular, the second end region extends over a maximum of 30%, in particular at least 10%, of an axial length of the receiving space. In other words, the second biasing region is arranged on an open side of the receiving space where the interchangeable battery pack may be inserted. This means that the interchangeable battery pack is held in the receiving space by both the first biasing region and the second biasing region by way of a biasing force. The fact that a biasing force is exerted at both two axial ends by way of the corresponding biasing region enables a particularly robust and durable mounting, which can in particular prevent or reduce relative movements between the interchangeable battery pack and the consumer housing.

Particularly preferably, the biasing regions extend towards the receiving space such that the receiving space is reduced in the area of the biasing regions and through the biasing regions, in particular when the interchangeable battery pack is not inserted. That is to say, when the receiving space is empty, the biasing regions at least partially extend into the receiving space and reduce its size. When the interchangeable battery pack is inserted, the biasing regions are pushed aside and deformed by the interchangeable battery pack, causing the biasing regions to apply the biasing force on the interchangeable battery pack. This allows the biasing of the interchangeable battery pack to be provided in the receiving space in a particularly simple and cost-effective design.

Further preferably, the biasing element further comprises at least one third biasing region arranged at a different circumferential position of the receiving space with respect to at least one of the further biasing regions. In particular, the third biasing region is arranged in the insertion direction at the same axial height as the first biasing region or the second biasing region. In other words, at least two of the biasing regions are arranged around the circumference of the interchangeable battery pack. Particularly preferably, the biasing element has a total of four biasing regions, wherein two biasing regions are axially aligned and two biasing regions are arranged axially at the same height and at different circumferential positions. By this, a biasing force can be applied to the interchangeable battery pack at a total of four positions, thereby allowing for a particularly robust and reliable mounting of the interchangeable battery pack in the consumer housing.

Preferably, at least two biasing regions have different elasticities. Particularly preferably, the biasing regions with the corresponding different elasticities are configured such that a higher biasing force is applied to the first end region lying along the insertion direction than to a second end region lying opening opposite the insertion direction near the insertion opening. This ensures that the interchangeable battery pack is held securely in the consumer housing, making it particularly easy and smooth to insert the interchangeable battery pack.

Preferably, the biasing element is configured and arranged in such a way that the biasing force is achieved by a defined, in particular elastic, deformation of at least 0.1 mm, preferably at least 0.3 mm, of the biasing element. As a result, vibrations and mechanical forces, and the like, can be particularly reliably compensated for without significant relative movement between the interchangeable battery pack and the consumer housing.

Further preferably, the biasing element is configured and arranged to be replaceable. It is particularly preferable for the biasing element is to be attachable to the consumer housing by way of a friction-locking connection and/or by way of a positive-locking connection, in particular by way of the connecting elements. The biasing element can thus be replaced particularly simply and cost-efficiently, for example in the event of wear.

Preferably, the biasing element comprises two connecting elements for the friction-locking and/or positive-locking connection of the biasing element, in particular to the consumer housing. Preferably, the two connecting elements are arranged at a first distance from each other. The first distance is greater than a second distance between the two biasing regions. In particular, the connecting elements may be configured as clips or recesses by way of which the connecting element can be attached to the consumer housing. The fact that the two connecting elements are arranged further apart than the two biasing regions enables a particularly robust fastening of the biasing element and a stable construction for generating the biasing force.

Preferably, the biasing element comprises a base body, which extends in a particularly flat manner. The connecting elements are arranged on the base body. Preferably, the connecting elements are arranged on a first side of the base body and the biasing regions are arranged on a side of the base body facing away from the connecting elements. The base body preferably extends longitudinally, substantially at least partially in one plane. This can provide a simple, cost-effective and compact design for the biasing element.

Preferably, the biasing element comprises two wing elements that extend obliquely starting from the base body. The biasing elements are arranged on the wing elements. In particular, a biasing region is arranged on exactly one wing element in each case. In particular, the wing elements are arranged obliquely to the base body in a cross-sectional plane starting from the base body. By this, a particularly defined elasticity of the biasing element can be provided, which can generate the biasing force by elastic deformation.

Preferably, the consumer housing comprises at least two housing parts which are attached to one another at at least one connecting region. The biasing element is arranged at the connecting region or adjacent to the connecting region. In particular, the housing parts can be joined to one another at a separation plane that is parallel to the longitudinal direction or in which the longitudinal direction lies. The connecting region may comprise, for example, a screw connection by way of which the two housing parts can be screwed together. The fact that the biasing element, in particular the biasing regions of the biasing element, is arranged at the connecting region enables a particularly robust construction and reliable function of the biasing element. In particular, the consumer housing has a particularly robust configuration in the connecting regions, which allows the biasing element to be reliably and immovably supported, enabling the desired biasing force to be produced in a particularly targeted and reliable manner.

Further preferably, the consumer housing may comprise at least two housing parts, wherein the biasing element is inserted between the housing parts. In particular, a recess can be configured in each housing part in which at least a part of the biasing element can be arranged for fastening. This allows for a particularly simple, cost-effective and lightweight design of the consumer device with few components.

Preferably, the biasing element is cylindrical. In this case, the biasing element can in particular be configured as a cylinder made of a plastic. This enables a particularly simple and cost-effective design of the consumer.

Preferably, the consumer further comprises at least one contact region arranged on the consumer housing. The contact region is configured for electrical contacting with the interchangeable battery pack. In particular, the contact region and the biasing element are arranged along a direction orthogonal to the insertion direction on opposite sides of the receiving space. In other words, the interchangeable battery pack is pressed in the inserted state by the biasing element towards the contact region by way of the biasing force. By this, a particularly robust attachment of the interchangeable battery pack in the receiving space can be enabled, wherein the electrical contact between the interchangeable battery pack and the consumer can be reliably ensured.

Further preferably, the consumer comprises an interchangeable battery pack. In particular, the interchangeable battery pack comprises an electrical contact region configured for electrical contact with the contact region of the consumer.

### BRIEF DESCRIPTION OF THE DRAWINGS

Exemplary embodiments of the disclosure are explained in detail below with reference to the accompanying drawings. The drawing shows:

FIG. 1 a simplified schematic view of a consumer according to a third exemplary embodiment of the disclosure,

FIG. 2 a detailed view of an interchangeable battery pack of the consumer of FIG. 1,

FIG. 3 a perspective detail view of the consumer of FIG. 1,

FIG. 4 an exploded view of the consumer of FIG. 1,

FIG. 5 a detail view of the consumer of FIG. 1,

FIG. 6 a simplified schematic detail sectional view of a consumer according to a second exemplary embodiment of the disclosure,

FIG. 7 a simplified schematic detail sectional view of a consumer according to a third exemplary embodiment of the disclosure,

FIG. 8 a detail view of the consumer of FIG. 7,

FIG. 9 an alternative detail sectional view of the consumer of FIG. 7,

FIG. 10a further alternative detail sectional view of the consumer of FIG. 7, and

FIG. 11a further detail of the consumer of FIG. 7.

### DETAILED DESCRIPTION

Preferably, all identical components, elements, and/or units are provided with the same reference symbols in all figures.

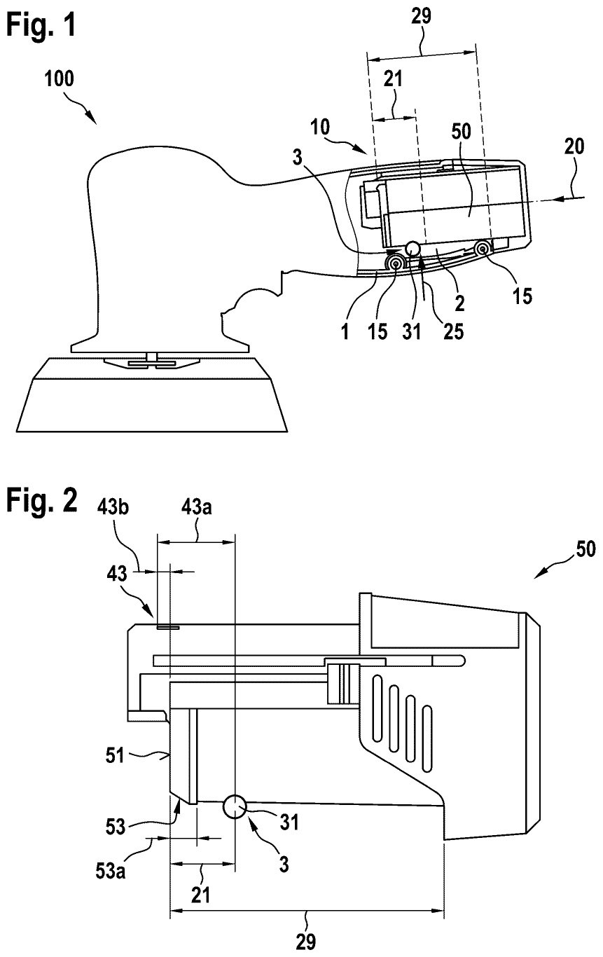

FIG. 1 shows a simplified schematic view of a consumer 100 according to a first exemplary embodiment of the disclosure, Details of the consumer 100 of FIG. 1 are shown in FIGS. 2 to 5.

The consumer 100 comprises an interchangeable battery pack 50, which is provided as an electrical energy store.

The consumer 100 is a hand-held power tool, in particular a grinding device. An electric motor of the consumer 100 may be powered by the electrical power stored in the interchangeable battery pack 50.

The consumer 100 also includes a battery interface 10, which is in particular arranged in a handle of the consumer 100. The battery interface 10 comprises a consumer housing 1 having a receiving space 2.

The receiving space 2 is open on one side so that the interchangeable battery pack 50 can be inserted into the receiving space 2 along an insertion direction 20. In a fully inserted state, which is shown in FIG. 1, a part of the interchangeable battery pack 50 is arranged within the receiving space 2 of the consumer housing 1.

Preferably, a mechanical interface is configured between the consumer housing 1 and the interchangeable battery pack 2, which, in the fully inserted state, releasably locks the interchangeable battery pack 50 on the consumer housing 1.

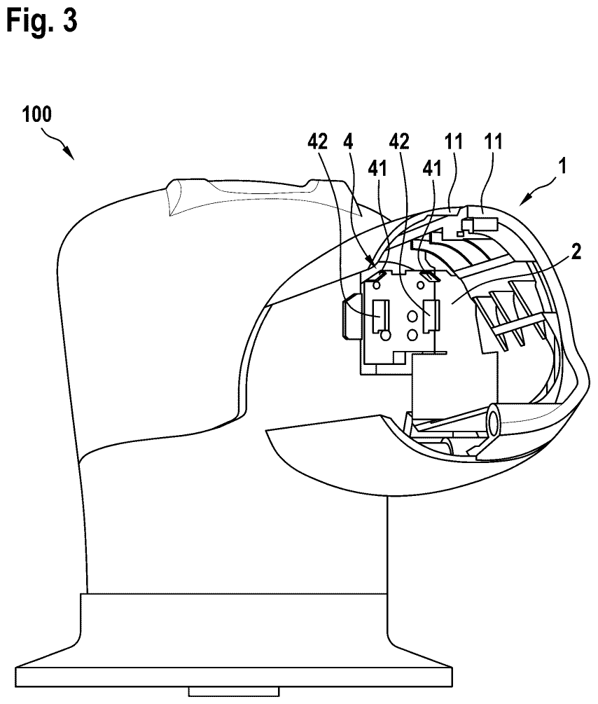

In addition, an electrical interface is provided that allows the electrical connection between the interchangeable battery pack 50 and the consumer 100. The electrical interface comprises an electrical contact region 4, which is arranged on the consumer housing 1 (cf. FIG. 3).

The electrical contact region 4 includes data contacts 41 configured to transmit electrical data signals, such as temperature signals, an individual identifier of the interchangeable battery pack 50, or other information. In addition, the electrical contact region 4 comprises power contacts 42, which are configured to transmit the electrical current.

The battery interface 10 of the consumer 100 further comprises a biasing element 3 arranged on the consumer housing 1. The biasing element 3 is formed from a resilient material and has cylindrical geometry.

The biasing element 3 is arranged at an edge of the receiving space 2 and is arranged such that it projects into the receiving space 2, in the uninserted state of the interchangeable battery pack 50. This causes the biasing element 3 to be elastically deformed by the interchangeable battery pack 50 upon insertion of the interchangeable battery pack 50. As a result, in the fully inserted state of the interchangeable battery pack 50, the biasing element 3 applies a biasing force 25 to the interchangeable battery pack 50 by elastic deformation. The biasing force 25 presses the interchangeable battery pack 50 permanently against a part of the consumer housing 1 during operation of the consumer 100. This causes a completely play-free arrangement of the interchangeable battery pack 50 within the consumer housing 1. This allows for a particularly robust and durable attachment of the interchangeable battery pack 50 in the consumer housing 1.

In particular, the biasing element 3 and its generated biasing force 25 are configured to ensure a fixed, play-free mounting of the interchangeable battery pack 50 for all vibrations occurring during operation of the consumer 100. Thus, relative movements and wear and loosening of the attachment of the interchangeable battery pack 50 can be reliably avoided. In particular, it is thus ensured that the mechanical interface can reliably enable attachment of the interchangeable battery pack 50 to the consumer housing 1 over a particularly long service life.

A particularly advantageous configuration and use can be achieved by the specific arrangement of the biasing element 3 on the consumer housing 1 and geometrical configurations of the interchangeable battery pack 50, which are described below in particular with respect to FIGS. 1 and 2.

The biasing element 3, which has a first biasing region 31, which in particular in the first exemplary embodiment covers the entire biasing element 3, is arranged at a first end region 21 of the receiving space 2 lying in the insertion direction 20. The first end region 21 extends over a maximum of 30%, in particular at least 5%, of an axial length 29 of the receiving space 2.

An insertion length of the interchangeable battery pack 50 can be considered as the axial length 29. Preferably, the axial length 29 extends from an end face 51 on a region of the interchangeable battery pack 50 facing the biasing element 3 in the axial direction up to an end of the receiving space 2. For example, the interchangeable battery pack 50 may extend axially beyond the end face 51 on the side of the contact region 4 where the contacts 43 of the interchangeable battery pack 50 are arranged.

By having the biasing element 3 arranged far rearward in the receiving space 2 with respect to the insertion direction 20, the insertion of the interchangeable battery pack 50 can be carried out completely without any force over the majority of the insertion length. Only when the interchangeable battery pack 50 engages with the biasing element 3 is the biasing force 25 applied. As no significant insertion length must be overcome from this point onward, insertion can be carried out particularly easily and smoothly, with little wear on the biasing element 3 and the interchangeable battery pack 50.

For a particularly smooth insertion, the interchangeable battery pack 50 can have an insertion chamfer 53, which extends in particular over a length 53a, which preferably corresponds to a maximum of 30%, in particular at least 10%, of the length of the end region 21.

An axial distance 43a of the contacts 43 from the biasing element 3 is in particular greater than the axial length of the first biasing region 31. Particularly preferably, the axial length 43a is at least twice as large as the length 53a. Further preferably, the distance 43a is at least twice as large as a distance 43b of the contacts 43 from the front face 51.

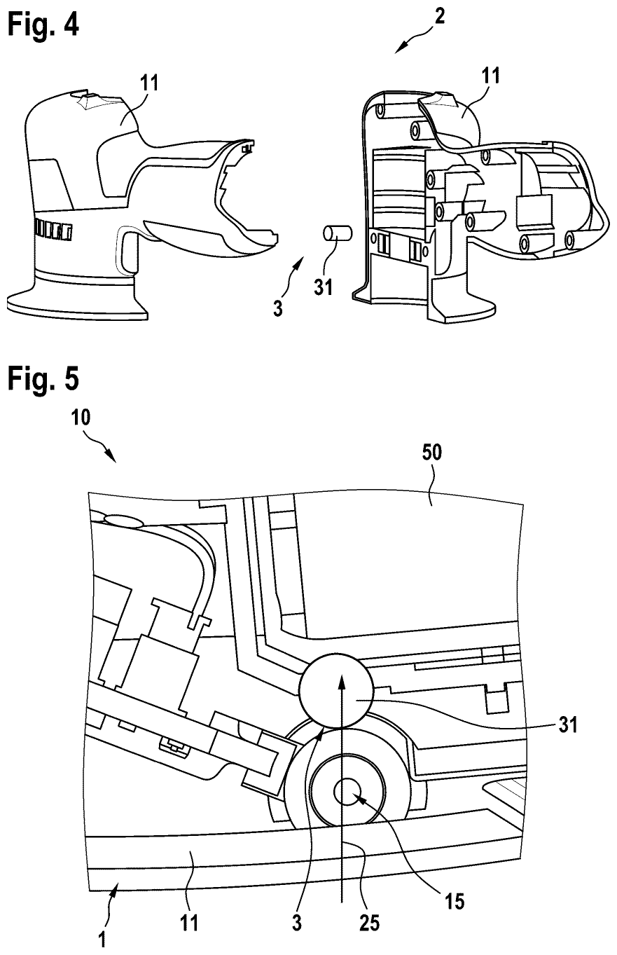

The attachment of the biasing element 3 in the first exemplary embodiment is carried out by having it inserted between two housing parts 11, as can be seen in FIG. 4. The biasing element 3 can be inserted into respective pockets in each housing part 11, for example. By this, particularly simple and time-efficient assembly of the consumer 100 can occur.

The consumer 100 is assembled by screwing the housing parts 11 to at least one connecting region 15 (cf. FIGS. 1 and 5). In particular, the screws are tightened along a direction orthogonal to the separation plane of the housing parts 11. As can be seen in FIG. 5, the biasing element 3 is arranged directly adjacent to the connecting region 15. This allows for a particularly robust construction. In particular, this prevents the housing parts 11 from diverging when screws together, for example.

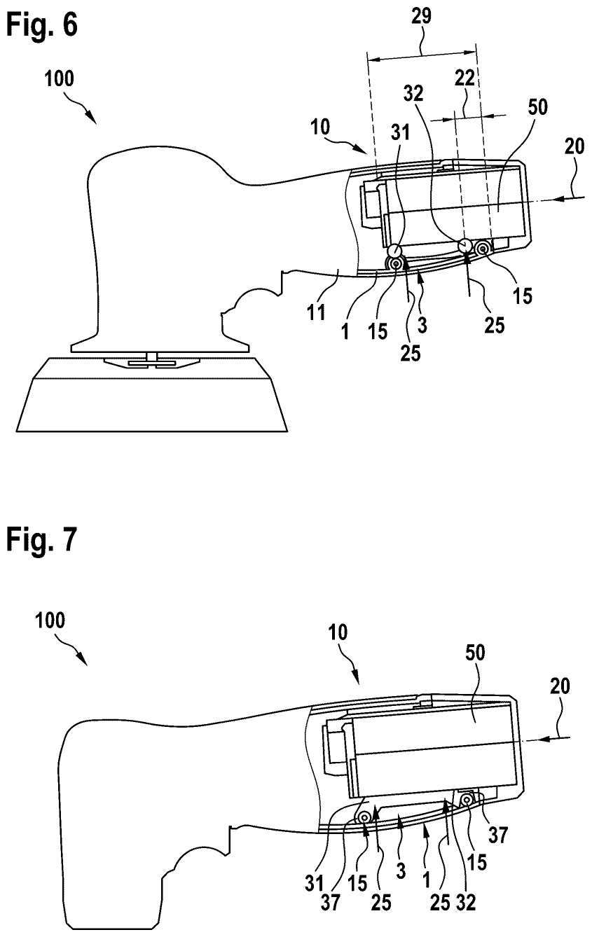

FIG. 6 shows a simplified schematic view of a consumer 100 according to a second exemplary embodiment of the disclosure. The second exemplary embodiment substantially corresponds to the first exemplary embodiment of FIGS. 1 to 5, with the difference that the biasing element 3 comprises an additional second biasing region 32, which is arranged in a second end region 22 of the receiving space 2 opposite the insertion direction 20.

The second end region 22 extends over a maximum of 30%, in particular at least 10%, of the axial length 29 of the receiving space 2, starting from a rear open end of the receiving space 2, which is opposite the insertion direction 20.

The second biasing region 32 is arranged on the same side of the receiving space 2 as the first biasing region 31 with respect to a radial direction. The second biasing region 32 is also configured to apply a biasing force 25 to the interchangeable battery pack 50 when inserted.

The second biasing region 32 may also have cylindrical geometry.

Preferably, the first biasing region 31 and the second biasing region 32 may be identical in terms of material and biasing force 25. Alternatively, the second biasing region 32 may be formed from a softer material than the first biasing region 31.

In addition, the second biasing region 32 preferably has better sliding properties than the first biasing region 31. By this, a smoother insertion of the interchangeable battery pack 50 can be enabled.

The additional second biasing range 32 provides the advantage that a mechanical bias of the interchangeable battery pack 50 can occur at two widely spaced points. By this, a particularly reliable, robust attachment of the interchangeable battery pack 50 to the battery interface 10 can be enabled.

FIG. 7 shows a simplified schematic detail sectional view of a consumer 100 according to a third exemplary embodiment of the disclosure, The third exemplary embodiment substantially corresponds to the first second embodiment of FIG. 6, with the difference being an alternative embodiment of the biasing element 3. In the third exemplary embodiment, the biasing element 3 also comprises two separate biasing regions 31, 32 along the insertion direction 20. In the third exemplary embodiment, the biasing element 3 is configured as an integral component.

In detail, the biasing element 3 comprises a base body 30 which extends substantially in a flat plane.

Connecting elements 32 are arranged on the base body 30 at their respective axial ends, which are arranged for a friction-locking and/or a positive-locking connection to the consumer housing 1. In particular, the connecting elements 37 are substantially clip-shaped and can partially enclose a corresponding screw dome on the consumer housing 1 at each connecting region 15.

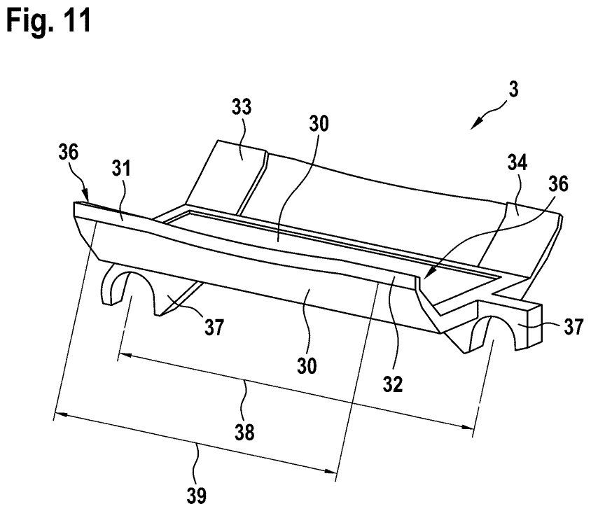

The connecting elements 37 are arranged at a first distance 38 to each other, which is greater than a second distance 39 of the two biasing regions 31, 32 (cf. FIG. 11). By this, a robust, broadly supported attachment of the biasing element 3 to the consumer housing 1 can be enabled.

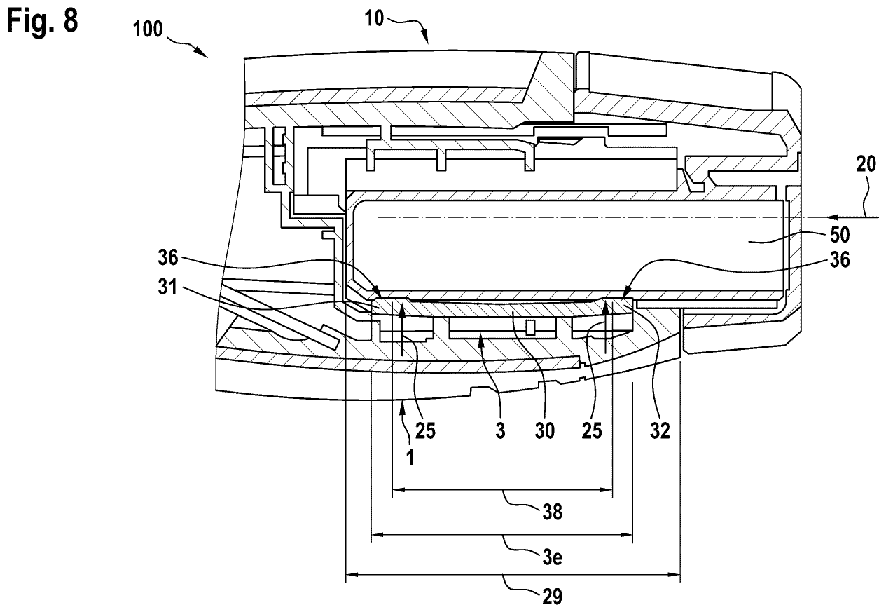

In the third exemplary embodiment, the biasing element 3 further comprises two wing elements 36, which extend diagonally upwardly towards the receiving space 2 in a cross-section starting from the base body 30 (cf. FIG. 8). The biasing regions 31, 32 are arranged on the wing elements 36. By this, the biasing force 25 can be specifically enabled only at the biasing regions 31, 32 with the simple construction of the biasing element 3.

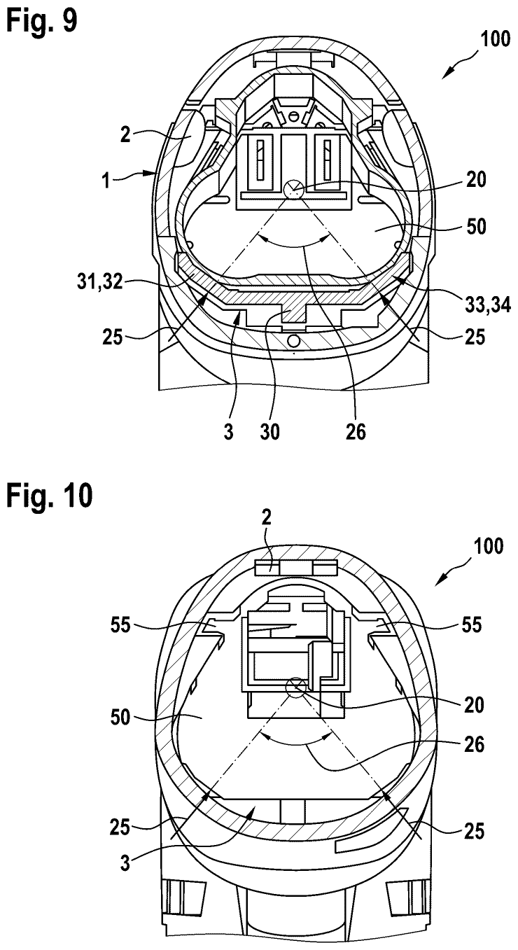

Each wing element 36 is provided with two biasing regions 31, 32, 33, 34, which are arranged at different circumferential positions of the receiving space 2, as can be seen in FIGS. 9 and 10. In detail, the biasing regions 31, 32, 33, 34 are arranged such that two biasing regions 31, 32, 33, 34 are axially aligned and two biasing regions 31, 32, 33, 34 are arranged at the same height along the insertion direction 20. The two biasing regions 31, 32, 33, 34, which are each distributed differently around the circumference, are arranged such that they each apply a biasing force 25 on the interchangeable battery pack 50, wherein the biasing forces 25 are arranged substantially at an angle 26 of approximately 90° (cf. FIGS. 9 and 10).

A total axial length 3e of the biasing element 3 is substantially at least 10%, preferably at most 15%, longer than the axial distance 38 of the biasing regions 31, 32.

As can be seen in FIG. 10, a guide geometry 55 can be formed between the interchangeable battery pack 50 and the consumer housing 1 along a direction parallel to the insertion direction 20. By this, a longitudinal guide of the interchangeable battery pack 50, for example by way of radially projecting elements of the interchangeable battery pack 50, which are guided in grooves in the consumer housing 1, can be provided. In particular, this ensures that the interchangeable battery pack 50 is pressed against the grooves of the guide geometry 55 by way of the biasing forces 25 and thus held in a precisely defined position in the consumer housing 1.

What is claimed is:

1. A consumer having a battery interface for connection to an interchangeable battery pack, comprising:
a consumer housing having a receiving space; and
a biasing element arranged on the consumer housing,
wherein the consumer housing is configured such that an interchangeable battery pack is insertable into the receiving space along an insertion direction, and
wherein the biasing element is configured and arranged so as to apply a biasing force at least partially orthogonal to the insertion direction on the interchangeable battery pack when it is inserted into the receiving space.

2. The consumer according to claim 1, wherein the biasing element is at least partially formed from a resiliently compliant material.

3. The consumer according to claim 1, wherein the biasing element comprises a first biasing region arranged at a first end region of the receiving space lying in the insertion direction, and wherein the first end region extends over a maximum of 30% and at least 5% of an axial length of the receiving space.

4. The consumer according to claim 3, wherein the biasing element comprises a second biasing region arranged at a second end region of the receiving space lying opposite the insertion direction, and wherein the second end region extends over a maximum of 30% and at least 10% of the axial length of the receiving space.

5. The consumer according to claim 3, wherein the biasing regions extend in the direction of the receiving space such that the receiving space is reduced in size in the region of the biasing regions and by the biasing regions.

6. The consumer according to claim 3, wherein the biasing element further comprises at least one third biasing region arranged at a different circumferential position of the receiving space in relation to at least one further biasing region.

7. The consumer according to claim 3, wherein at least two biasing regions have different elasticities.

8. The consumer according to claim 1, wherein the biasing element is configured and arranged in such a way as to effect the biasing force by way of a defined deformation of at least 0.1 mm of the biasing element.

9. The consumer according to claim 1, wherein the biasing element is configured and arranged to be replaceable, and wherein the biasing element is attachable to the consumer housing by way of a friction-locking and/or positive-locking connection.

10. The consumer according to claim 4, wherein the biasing element comprises two connecting elements for the friction-locking and/or positive-locking connection of the biasing element, and wherein the two connecting elements are arranged at a first distance to each other that is greater than a second distance of the two biasing regions.

11. The consumer according to claim 10, wherein the biasing element comprises a base body which extends in a flat plane, and wherein the connecting elements are arranged on the base body.

12. The consumer according to claim 6, wherein the biasing element comprises two wing elements extending obliquely from the base body, and wherein the biasing regions are arranged on the wing elements.

13. The consumer according to claim 1, wherein the consumer housing comprises at least two housing parts which are attached to one another at at least one connecting region, and wherein the biasing element is arranged at the connecting region or adjacent to the connecting region.

14. The consumer according to claim 1, further comprising at least one contact region arranged on the consumer housing and which is configured to electrically contact the interchangeable battery pack, and wherein the contact region and the biasing element are arranged along a direction orthogonal to the insertion direction on opposite sides of the receiving space.

15. The consumer according to claim 1, further comprising an interchangeable battery pack.

16. The consumer according to claim 1, wherein the biasing element is configured and arranged in such a way as to effect the biasing force by way of a defined deformation at least 0.3 mm of the biasing element.
